(19) United States
(12) Patent Application Publication
(10) Pub. No.: US 2014/0286390 A1
(43) Pub. Date: Sep. 25, 2014

(54) ENCODER CONTROLLER GRAPHICS PROCESSING UNIT AND METHOD OF ENCODING RENDERED GRAPHICS

(71) Applicant: NVIDIA CORPORATION, Santa Clara, CA (US)

(72) Inventor: Andrew Fear, Austin, TX (US)

(73) Assignee: Nvidia Corporation, Santa Clara, CA (US)

(21) Appl. No.: 13/847,594

(22) Filed: Mar. 20, 2013

(51) Int. Cl. H04N 7/26

(52) U.S. Cl. CPC H04N 19/00478
USPC 375/240.01

(57) ABSTRACT

An encoder controller graphics processing unit (GPU) and a method of encoding rendered graphics. One embodiment of the encoder controller GPU includes: (1) an encoder operable to encode rendered frames of a video stream for transmission to a client, and (2) an encoder controller configured to detect a mark embedded in a rendered frame of the video stream and cause the encoder to begin encoding.

### TECHNICAL FIELD

This application is directed, in general, to cloud graphics rendering and, more specifically, to encoder control in the context of cloud graphics rendering.

### BACKGROUND

The utility of personal computing was originally focused at an enterprise level, putting powerful tools on the desktops of researchers, engineers, analysts and typists. That utility has evolved from mere number-crunching and word processing to highly programmable, interactive workpieces capable of production level and real-time graphics rendering for incredibly detailed computer aided design, drafting and visualization. Personal computing has more recently evolved into a key role as a media and gaming outlet, fueled by the development of mobile computing. Personal computing is no longer resigned to the world's desktops, or even laptops. Robust networks and the miniaturization of computing power have enabled mobile devices, such as cellular phones and tablet computers, to carve large swaths out of the personal computing market. Desktop computers remain the highest performing personal computers available and are suitable for traditional businesses, individuals and gamers. However, as the utility of personal computing shifts from pure productivity to envelope media dissemination and gaming, and, more importantly, as media streaming and gaming form the leading edge of personal computing technology, a dichotomy develops between the processing demands for “everyday” computing and those for high-end gaming, or, more generally, for high-end graphics rendering.

The processing demands for high-end graphics rendering drive development of specialized hardware, such as graphics processing units (GPUs) and graphics processing systems (graphics cards). For many users, high-end graphics hardware would constitute a gross under-utilization of processing power. The rendering bandwidth of high-end graphics hardware is simply lost on traditional productivity applications and media streaming. Cloud graphics processing is a centralization of graphics rendering resources aimed at overcoming the developing misallocation.

In cloud architectures, similar to conventional media streaming, graphics content is stored, retrieved and rendered on a server where it is then encoded, packetized and transmitted over a network to a client as a video stream (often including audio). The client simply decodes the video stream and displays the content. High-end graphics hardware is thereby obviated on the client end, which requires only the ability to decode and play video. Graphics processing servers centralize high-end graphics hardware, enabling the pooling of graphics rendering resources where they can be allocated appropriately upon demand. Furthermore, cloud architectures pool storage, security and maintenance resources, which provide users easier access to more up-to-date content than can be had on traditional personal computers.

Perhaps the most compelling aspect of cloud architectures is the inherent cross-platform compatibility. The corollary to centralizing graphics processing is offloading large complex rendering tasks from client platforms. Graphics rendering is often carried out on specialized hardware executing proprietary procedures that are optimized for specific platforms running specific operating systems. Cloud architectures need only a thin-client application that can be easily portable to a variety of client platforms. This flexibility on the client side lends itself to content and service providers who can now reach the complete spectrum of personal computing consumers operating under a variety of hardware and network conditions.

### SUMMARY

One aspect provides a graphics processing unit (GPU), including: (1) an encoder operable to encode rendered frames of a video stream for transmission to a client, and (2) an encoder controller configured to detect a mark embedded in a rendered frame of the video stream and cause the encoder to begin encoding.

Another aspect provides a method of encoding rendered graphics, including: (1) rendering frames of a video stream and capturing the frames for encoding, (2) detecting a mark embedded in at least one of the frames, and (3) encoding the at least one of the frames and all subsequent frames of the video stream for transmission to a client upon detection.

Yet another aspect provides a graphics rendering server, including: (1) a central processing unit (CPU) configured to execute a graphics application, thereby generating rendering commands and scene data including a mark embedded in at least one frame, and (2) a GPU configured to employ the rendering commands and scene data to render frames of a video stream and having: (2a) an encoder configured to encode the frames for transmission to a client, and (2b) an encoder controller operable to detect the mark and cause the encoder to begin encoding.

### BRIEF DESCRIPTION

Reference is now made to the following descriptions taken in conjunction with the accompanying drawings, in which:

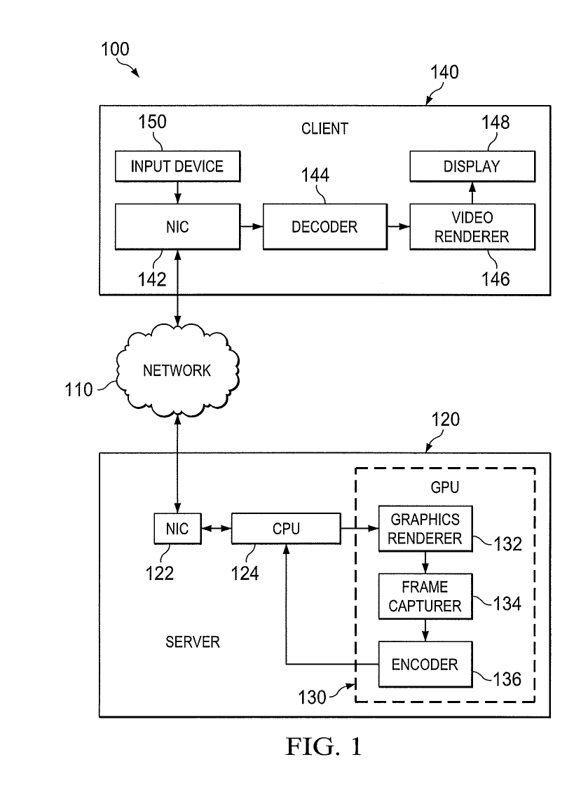

FIG. 1 is a block diagram of a cloud graphics rendering system;

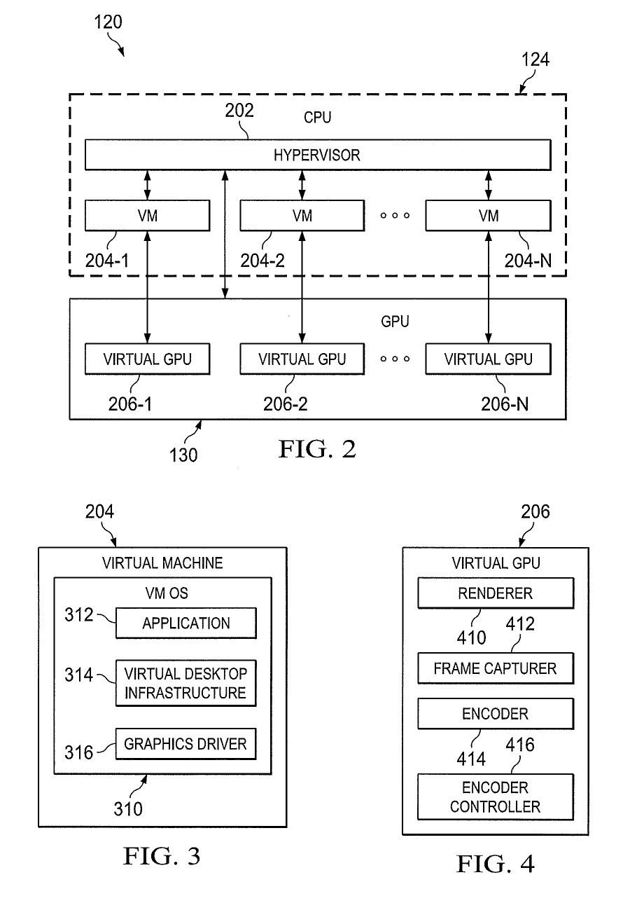

FIG. 2 is a block diagram of a cloud graphics rendering server;

FIG. 3 is a block diagram of a virtual machine within a cloud graphics rendering server;

FIG. 4 is a block diagram of a virtual GPU within a cloud graphics rendering server; and

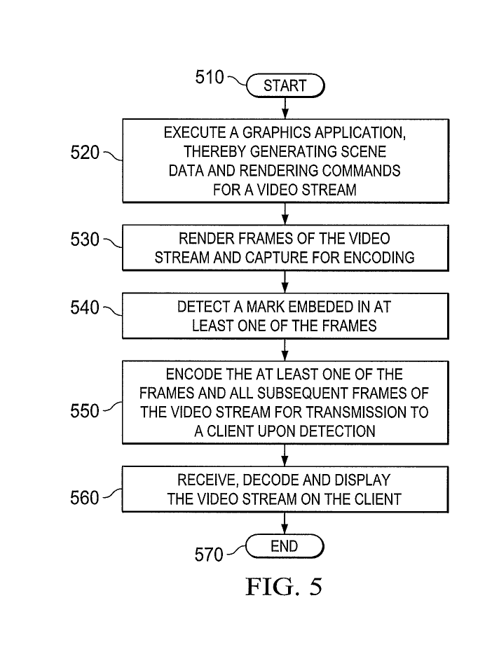

FIG. 5 is a flow diagram of one embodiment of a method of encoding rendered graphics.

### DETAILED DESCRIPTION

Cloud graphics processing, or rendering, is basically an offloading of complex processing from a client to a remote computer, or server. The server may support multiple simultaneous clients, each desiring to execute, render, display and interact with some graphics application, for example: a game. The server, which is often maintained and operated by a cloud service provider, uses a pool of computing resources to provide the cloud rendering, or “remote” rendering. A graphics application executes on the server on a traditional central processing unit (CPU), which generates all scene data and rendering commands necessary for rendering a video stream. A GPU then carries out the rendering commands on the scene data and renders the video stream. It is at this point conventional rendering departs from cloud rendering. In cloud rendering, rendered frames are captured and encoded for transmission over a network (for example, the internet) to a thin client. Encoding is generally a formatting or video compression that makes the video stream more amenable to transmission. The thin client need only unpack the received video stream, decode and display.

One of the challenges in this process is determining when to begin encoding rendered graphics for transmission. When a client initiates the execution of a graphics application, the server must recall the application from memory and execute it via a processor, as it would on any machine, remote or local. The graphics application running on the server operates within an operating system (OS) on the server, or possibly even on a virtual machine within the server architecture. There is time between a client's initiation and the desired graphics output from the GPU. The GPU shifts from rendering a blank screen or an OS background, to introduction screens and splash screens of the graphics application, to rendering whatever desired video stream is generated by the graphics application. It would be a waste of GPU and network resources to encode and transmit rendered graphics before the desired video stream is loaded and being rendered. Furthermore, there could be content that simply should remain hidden from the client, such as pop-ups and prompts that would be undesirable to transmit to the client for display.

One approach to this challenge is for developers to initiate encoding by incorporating specialized commands into their applications. This involves the use of special application programming interfaces (APIs) that are often proprietary and subject to maintenance issues like incomplete or “buggy” software releases and updates. Another approach is to run special image recognition software to watch for a startup screen. Here, the problem is that each application the server executes is different, and the recognition algorithms cannot reliably identify the startup screens.

It is realized herein an improved mechanism is needed for controlling the encoding of cloud rendered graphics. A mechanism is needed that is robust enough to work for any application but without the dependence on proprietary APIs or additional software. It is realized herein the solution can be contained within the GPU itself by embedding control in the rendered graphics.

Among the various modules of the GPU, there are limited means for control. Specialized commands incorporated in the graphics application, whether they are rendering commands or recognition commands, funnel through an API for the GPU. The GPU is focused on scene data and rendering commands that can be carried out by a rendering module in the GPU. The focus of the data flow is the graphics pipeline, where scene data marches along through the various rendering stages until rendered frames appear in the output. For instance, in the pipeline described above (rendering, capturing and encoding), scene data and rendering commands flow into the rendering module, frames of rendered video are captured and then encoded by an encoder. A control signal from the renderer to either the frame capture module or encoder would fall outside the primary data flow. By embedding control signals in the rendered graphics, it is realized herein, the various modules within the GPU can be controlled without disrupting the primary data flow through the pipeline.

It is realized herein that graphics application developers can embed a defined mark, or “watermark,” in their application, that is rendered along with all other scene data and is detectable within the GPU. The mark can be as simple as a single defined pixel, or as elaborate as a highly customized image. The mark is a set of one or more pixels the developer embeds in the first frame or sequence of frames the developer wants to be encoded and ultimately transmitted to the thin client. It is realized herein this could be the very first frame generated by the application, it could be a frame or frames several seconds or hundreds of frames into the rendering. As frames embedded with the mark are rendered, the GPU detects the mark in an encoder controller module and thereby enables the encoder. The encoder then begins encoding the video stream for transmission. It is further realized herein the encoder controller module can be incorporated into the encoder itself or reside in its own module within the GPU.

Before describing various embodiments of the encoder controller GPU or method of encoding rendered graphics introduced herein, a cloud graphics rendering system in which the encoder controller GPU or method may be embodied or carried out will be generally described.

FIG. 1 is a block diagram of a cloud gaming system 100. Cloud gaming system 100 includes a network 110 through which a server 120 and a client 140 communicate. Server 120 represents the central repository of gaming content, processing and rendering resources. Client 140 is a consumer of that content and those resources. Server 120 is freely scalable and has the capacity to provide that content and those services to many clients simultaneously by leveraging parallel and apportioned processing and rendering resources. The scalability of server 120 is limited by the capacity of network 110 in that above some threshold of number of clients, scarcity of network bandwidth requires that service to all clients degrade on average.

Server 120 includes a network interface card (NIC) 122, a central processing unit (CPU) 124 and a GPU 130. Upon request from Client 140, graphics content is recalled from memory via an application executing on CPU 124. As is convention for graphics applications, games for instance, CPU 124 reserves itself for carrying out high-level operations, such as determining position, motion and collision of objects in a given scene. From these high level operations, CPU 124 generates rendering commands that, when combined with the scene data, can be carried out by GPU 130. For example, rendering commands and data can define scene geometry, lighting, shading, texturing, motion, and camera parameters for a scene.

GPU 130 includes a graphics renderer 132, a frame capturer 134 and an encoder 136. Graphics renderer 132 executes rendering procedures according to the rendering commands generated by CPU 124, yielding a stream of frames of video for the scene. Those raw video frames are captured by frame capturer 134 and encoded by encoder 136. Encoder 134 formats the raw video stream for transmission, possibly employing a video compression algorithm such as the H.264 standard arrived at by the International Telecommunication Union Telecommunication Standardization Sector (ITU-T) or the MPEG-4 Advanced Video Coding (AVC) standard from the International Organization for Standardization/International Electrotechnical Commission (ISO/IEC). Alternatively, the video stream may be encoded into Windows Media Video® (WMV) format, VP8 format, H.265 or any other video encoding format.

CPU 124 prepares the encoded video stream for transmission, which is passed along to NIC 122. NIC 122 includes circuitry necessary for communicating over network 110 via a networking protocol such as Ethernet, Wi-Fi or Internet Protocol (IP). NIC 122 provides the physical layer and the basis for the software layer of server 120's network interface.

Client 140 receives the transmitted video stream for display. Client 140 can be a variety of personal computing devices, including: a desktop or laptop personal computer, a tablet, a smart phone or a television. Client 140 includes a NIC 142, a decoder 144, a video renderer 146, a display 148 and an input device 150. NIC 142, similar to NIC 122, includes circuitry necessary for communicating over network 110 and provides the physical layer and the basis for the software layer of client 140's network interface. The transmitted video stream is received by client 140 through NIC 142.

The video stream is then decoded by decoder 144. Decoder 144 should match encoder 136, in that each should employ the same formatting or compression scheme. For instance, if encoder 136 employs the ITU-T H.264 standard, so should decoder 144. Decoding may be carried out by either a client CPU or a client GPU, depending on the physical client device. Once decoded, all that remains in the video stream are the raw rendered frames. The rendered frames a processed by a basic video renderer 146, as is done for any other streaming media. The rendered video can then be displayed on display 148.

An aspect of cloud gaming that is distinct from basic media streaming is that gaming requires real-time interactive streaming. Not only must graphics be rendered, captured and encoded on server 120 and routed over network 110 to client 140 for decoding and display, but user inputs to client 140 must also be relayed over network 110 back server 120 and processed within the graphics application executing on CPU 124. This real-time interactive component of cloud gaming limits the capacity of cloud gaming systems to “hide” latency.

FIG. 2 is a block diagram of server 120 of FIG. 1. This aspect of server 120 illustrates the capacity of server 120 to support multiple simultaneous clients. In FIG. 2, CPU 124 and GPU 130 of FIG. 1 are shown. CPU 124 includes a hypervisor 202 and multiple virtual machines (VMs), VM 204-1 through VM 204-N. Likewise, GPU 130 includes multiple virtual GPUs, virtual GPU 206-1 through virtual GPU 206-N. In FIG. 2, server 120 illustrates how N clients are supported. The actual number of clients supported is a function of the number of users ascribing to the cloud gaming service at a particular time. Each of VM 204-1 through VM 204-N is dedicated to a single client desiring to run a respective gaming application. Each of VM 204-1 through VM 204-N executes the respective gaming application and generates rendering commands for GPU 130. Hypervisor 202 manages the execution of the respective gaming application and the resources of GPU 130 such that the numerous users share GPU 130. Each of VM 204-1 through VM 204-N respectively correlates to virtual GPU 206-1 through virtual GPU 206-N. Each of the virtual GPU 206-1 through virtual GPU 206-N receives its respective rendering commands and renders a respective scene. Each of virtual GPU 206-1 through virtual GPU 206-N then captures and encodes the raw video frames. The encoded video is then streamed to the respective clients for decoding and display.

FIG. 3 is a block diagram of virtual machine (VM) 204 of FIG. 2. VM 204 includes a VM operating system (OS) 310 within which an application 312, a virtual desktop infrastructure (VDI) 314 and a graphics driver 316 operate. VM OS 310 can be any operating system on which available games are hosted. Popular VM OS 310 options include: Windows®, iOS®, Android®, Linux and many others. Within VM OS 310, application 312 executes as any traditional graphics application would on a simple personal computer. The distinction is that VM 204 is operating on a CPU in a server system (the cloud), such as server 120 of FIG. 1 and FIG. 2. VDI 314 provides the foundation for separating the execution of application 312 from the physical client desiring to gain access. VDI 314 allows the client to establish a connection to the server hosting VM 204. VDI 314 also allows inputs received by the client, including through a keyboard, mouse, joystick, hand-held controller, or touchscreens, to be routed to the server, and outputs, including video and audio, to be routed to the client. Graphics driver 316 is the interface through which application 312 can generate rendering commands that are ultimately carried out by a GPU, such as GPU 130 of FIG. 1 and FIG. 2 or virtual GPUs, virtual GPU 206-1 through virtual GPU 206-N.

Having generally described a cloud graphics rendering systems in which the encoder controller GPU or method of encoding rendered graphics may be embodied or carried out, various embodiments of the encoder controller GPU and method will be described.

FIG. 4 is a block diagram of virtual GPU 206 of FIG. 2. Virtual GPU 206 includes a renderer 410, a framer capturer 412, an encoder 414 and an encoder controller 416. Virtual GPU 206 is responsible for carrying out rendering commands for a single virtual machine, such as VM 204 of FIG. 3. Rendering is carried out by renderer 410 and yields raw video frames having a resolution. The raw frames are captured by frame capturer 412 at a capture frame rate and then processed by encoder controller 416. Encoder controller 416 checks captured frames for a defined embedded mark. The mark may be as little as a single defined pixel. Alternatively, the mark may be a complex image, or set of pixels. When encoder controller 416 detects the mark in a frame, it then enables encoder 414. Encoder 414 begins encoding at that frame and continues encoding each subsequent frame of the video stream until the graphics application terminates or encoding is somehow disabled. The encoding can be carried out at various bit rates and can employ a variety of formats, including H.264 or MPEG4 AVC. The inclusion of an encoder in the GPU, and, moreover, in each virtual GPU 206, reduces the latency often introduced by dedicated video encoding hardware or CPU encoding processes.

FIG. 5 is a flow diagram of one embodiment of a method of encoding rendered graphics. The method begins at a start step 510. In a step 520, a graphics application is executed on a processor in a server, such as a CPU. The graphics application generates scene data and a set of rendering commands to be used by a GPU in the server in generating a video stream. The GPU renders frames of the video stream in a step 530, and the rendered frames are captured for encoding. Rendering and frame capture may be carried out by distinct modules within the GPU. In that case, rendering would be carried out by a graphics renderer, while a frame capturer would perform the capturing. In certain embodiments, the server supports multiple clients simultaneously. In those embodiments, the server creates and manages client-dedicated virtual machines to execute the graphics application and client-dedicated virtual GPUs to carry out rendering, capturing and encoding. Each virtual GPU would contain the distinct modules mentioned above: a graphics renderer and a frame capturer, in addition to an encoder and encoder controller.

In a step 540, an embedded mark is detected in at least one of the rendered frames. The mark is embedded at the graphics application level and is rendered along with the usual scene data. In certain embodiments, the detection is performed by an encoder controller, which could be coupled directly to the encoder. In certain other embodiments, the encoder controller and encoder are distinct modules, the encoder controller being an enabler of the encoder itself. Once the mark is detected, encoding begins in a step 550. An encoder begins encoding on the frame in which the mark is detected and continues on all subsequent frames in the video stream. Encoding prepares the video stream for transmission to a client.

In a step 560, at the client, the transmitted encoded video stream is received. The received video stream is decoded and displayed on whatever local display device is used by the client. The method then ends in a step 570.

Those skilled in the art to which this application relates will appreciate that other and further additions, deletions, substitutions and modifications may be made to the described embodiments.

What is claimed is:

1. A graphics processing unit (GPU), comprising:
an encoder operable to encode rendered frames of a video stream for transmission to a client; and
an encoder controller configured to detect a mark embedded in a rendered frame of said video stream and cause said encoder to begin encoding.

2. The GPU recited in claim 1 wherein said mark is a square.

3. The GPU recited in claim 1 further comprising a frame capturer configured to capture said rendered frames for encoding.

4. The GPU recited in claim 1 further comprising a renderer configured to render said video stream.

5. The GPU recited in claim 5 wherein said renderer is operable to carry out rendering commands on scene data generated by a graphics application.

6. The GPU recited in claim 5 wherein said mark is a defined set of pixels incorporated into said graphics application.

7. The GPU recited in claim 1 wherein said mark is at least one defined pixel.

8. A method of encoding rendered graphics, comprising:
rendering frames of a video stream and capturing said frames for encoding;
detecting a mark embedded in at least one of said frames; and
encoding said at least one of said frames and all subsequent frames of said video stream for transmission to a client upon detection.

9. The method recited in claim 8 further comprising executing a graphics application thereby generating scene data and rendering commands for said video stream to be employed in said rendering.

10. The method recited in claim 9 wherein said executing yields at least one frame for rendering before said at least one of said frames.

11. The method recited in claim 9 wherein said executing is carried out by a virtual machine running on a central processing unit (CPU).

12. The method recited in claim 8 further comprising decoding and displaying said video stream on said client.

13. The method recited in claim 8 wherein said encoding includes H.264 video compression.

14. The method recited in claim 8 wherein said encoding is carried out by a graphics processing unit (GPU).

15. A graphics rendering server, comprising:
a central processing unit (CPU) configured to execute a graphics application, thereby generating rendering commands and scene data including a mark embedded in at least one frame; and
a graphics processing unit (GPU) configured to employ said rendering commands and scene data to render frames of a video stream and having:
an encoder configured to encode said frames for transmission to a client, and
an encoder controller operable to detect said mark and cause said encoder to begin encoding.

16. The graphics rendering server recited in claim 15 wherein said GPU includes a renderer operable to carry out said rendering commands on said scene data.

17. The graphics rendering server recited in claim 15 wherein said GPU includes a frame capturer configured to capture rendered frames of video for encoding.

18. The graphics rendering server recited in claim 15 wherein said encoder is further configured to employ a H.264 video compression scheme.

19. The graphics rendering server recited in claim 15 wherein said encoder is a component of one of a plurality of virtual GPUs within said GPU.

20. The graphics rendering server recited in claim 15 wherein said mark comprises at least one defined pixel detectable by said GPU.
